(19) United States
(12) Patent Application Publication
(10) Pub. No.: US 2007/0210907 A1
(43) Pub. Date: Sep. 13, 2007

(54) Illuminated motorcycle fairing element

(76) Inventor: Mathew Randolph Aron, San Diego, CA (US)

Correspondence Address: PETER MARTINEZ, P.O. BOX 131313, CARLSBAD, CA, 92013, US

(21) Appl. No.: 11/801,327

(22) Filed: May 9, 2007

Related U.S. Application Data
(63) Continuation-in-part of application No. 11/174,038, filed on Jun. 29, 2005.

(51) Int. Cl. B60Q 1/34

(52) U.S. Cl. 340/465

(57) ABSTRACT

An illuminated motorcycle fairing element is provided. In one embodiment, a trim element shaped as an elongated member is sized to fit adjacent to a motorcycle fairing and a motorcycle windshield. A plurality of light elements is coupled to the trim element, and at least one electrical connector communicates with at least one of the plurality of light elements. The electrical connector is structured to couple to a motorcycle wiring harness that provides electricity to illuminate the light elements. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

This application claims priority under 35 U.S.C. § 120 as a continuation-in-part of U.S. patent application Ser. No. 11/174,038, filed Jun. 29, 2005, entitled “Integrated Motorcycle Light Frame and Turn Signal Assembly.”

### FIELD OF THE INVENTION

The present invention generally relates to vehicle lighting. More particularly, the invention concerns an illuminated motorcycle fairing element.

### BACKGROUND OF THE INVENTION

The popularity of motorcycling continues to increase. Riders are attracted to the freedom of the open road, leaving behind the cares and worries of everyday life. Motorcycle manufacturers have seized upon the recent surge in popularity and have been selling motorcycles and accessories in record numbers.

While luring riders with their freedom and performance, motorcycles are substantially more dangerous than automobiles. A motorcycle rider almost always fares much worse than an automobile driver when an accident between the two vehicles occurs. With the increase in motorcycle popularity, has come an increase in motorcycle accidents. In response, some states have mandated that motorcycle riders must wear helmets, and also suggest that they wear reflective vests and protective clothing.

Motorcycle manufacturers have also introduced several safety features aimed at increasing safety. For example, motorcycle headlights are always illuminated, day or night. Brake performance has improved, decreasing braking distances, and tire reliability has reduced blow-out incidents. Still, statistics show that motorcycles continue to be many times more dangerous than automobiles.

Therefore, there exists a need for an apparatus that improves motorcycle safety, while also improving motorcycle aesthetics.

### BRIEF DESCRIPTION OF THE DRAWINGS

Various embodiments of the present invention taught herein are illustrated by way of example, and not by way of limitation, in the figures of the accompanying drawings, in which:

FIG. 1 is a front view of a motorcycle with one embodiment of the present invention mounted thereon;

FIG. 2 is a front view of the embodiment of the present invention shown in FIG. 1;

FIG. 3 is a sectional view taken through cutting plane 3-3 of FIG. 2;

FIG. 4 is a front view of a motorcycle with one embodiment of an illuminated fairing element mounted thereon; and

FIG. 5 is a perspective view of a motorcycle with another embodiment of an illuminated fairing element mounted thereon.

It will be recognized that some or all of the Figures are schematic representations for purposes of illustration and do not necessarily depict the actual relative sizes or locations of the elements shown. The Figures are provided for the purpose of illustrating one or more embodiments of the invention with the explicit understanding that they will not be used to limit the scope or the meaning of the claims.

Features and advantages of the present invention will be appreciated from review of the following detailed description of the invention, along with the accompanying figures in which like reference numerals are used to describe the same, similar or corresponding parts in the several views of the drawings.

### DETAILED DESCRIPTION OF EMBODIMENTS OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The present invention provides an integrated light frame and turn signal assembly that includes both turn-signals integrated into the headlight frame, or bezel. One feature of the present invention is that the manufacturer installed turn signal lights may be eliminated. Alternatively, for those motorcycle owners who wish to increase safety by increasing their “conspicuity” (i.e., their visibility), the additional lights provided by the integrated light frame and turn signal assembly 5 provide additional warning to on-coming motorists that the motorcycle rider wishes to turn.

Motorcycles have been in production for over 100 years, built by manufacturers such as Aprilla, BMW, Buell, Ducati, Harley-Davidson, Honda, Indian, Kawasaki, Moto Guzzi, Suzuki, Triumph, Victory, Yamaha, and others. It will be appreciated that the present invention may be installed on any motorcycle built by the above-listed manufacturers, or other un-named manufacturers (some, or all of the above-listed manufacturer names may be registered trademarks of their respective owners).

One manufacturer that has become very popular in the United States, as well as through-out the world, is Harley-Davidson. Harley-Davidson manufactures many different models of motorcycles, which may be generally categorized into five different types: Touring models, Softail models, Sportster models, Dyna Glide models, and V-Rod models (Harley-Davidson is a registered trademark of H-D Michigan, Inc., of Ann Arbor Mich.).

For example, touring models may include the FLHT Electra Glide standard, FLHTC Electra Glide classic, FLHTCU Ultra Classic Electra Glide, FLHTP Electra Glide police, FLHS Electra Glide sport, FLHR Road King, FLHRC Road King classic, FLHP Road King police, FLTC Tour Glide classic, FLTCU Ultra classic tour Glide, FLTR Road Glide, FLHRS Road King custom, FLHRI Road King, FLHRSI Road King custom, FLHRCI Road King classic, FLTRI Road Glide, FLHTI Electra Glide standard, FLHTCI Electra Glide classic, and the FLHTCUI Ultra Classic Electra Glide (some or all of the above model names may be registered trademarks of H-D Michigan, Inc., of Ann Arbor Mich.).

Sportster models may include the Sportster XL883, Sportster XL883L, Sportster XL883C, Sportster XL883C custom, Sportster XL883R, Sportster XLH883, Sportster XLH883 Hugger, Sportster XLH883 Deluxe, Sportster XL1200C, Sportster XL1200C custom, Sportster XL1200R, Sportster XL1200R Roadster, Sportster XLH1200, and the Sportster 1200S Sport (some or all of the above model names may be registered trademarks of H-D Michigan, Inc., of Ann Arbor Mich.).

Dyna Glide models may include the FXD Dyna Super Glide, FXDX Dyna Super Glide sport, FXDXT Dyna Super Glide T-sport, FXDL Dyna Low Rider, FXDP Dyna Defender, FXDS-CONV Dyna Convertible, FXDWG Dyna Wide Glide, FXDC/I Super Glide Custom, FXDI Dyna Super Glide, FXDXI Dyna Super Glide sport, FXDCI Super Glide custom, FXDLI Dyna Low Rider, and the FXDWGI Dyna Wide Glide (some or all of the above model names may be registered trademarks of H-D Michigan, Inc., of Ann Arbor Mich.).

V-Rod models may include the VRSCA V-Rod, VRSCB V-Rod, and the VRSCR Street Rod (some or all of the above model names may be registered trademarks of H-D Michigan, Inc., of Ann Arbor Mich.).

Softail models may include the FXST Softail Standard, FXSTI Softail Standard, FXSTB Night Train, FXSTBI Night Train, FXSTSI Springer Softail, FXSTDI Deuce, FLSTF Fat Boy, FLSTFI Fat Boy, FLSTFI Fat Boy 15^{th} Anniversary Special Edition, FLSTNI Softail Deluxe, FLSTSCI Softail Springer Classic, FLSTC Heritage Softail Classic, FLSTCI Heritage Softail Classic, FLSTN Heritage Softail Special, FLSTS Heritage Springer, FXSTC Softail Custom, FXSTD Softail Deuce, FXSTS Springer Softail, and the FXSTSB Bad Boy (some or all of the above model names may be registered trademarks of H-D Michigan, Inc., of Ann Arbor Mich.).

Clearly, Harley-Davidson manufactures many different motorcycle models. It will be appreciated that the present invention may be installed on any of the above-listed models, or on other models yet to be manufactured. In addition, the present invention may be installed on a “custom” motorcycle, which is a motorcycle that differs from a manufacturer-produced model. For example, a custom motorcycle may be a Harley-Davidson FXST Softail Standard that has had specific parts either added, removed or modified. Or, a custom motorcycle may be built from scratch, using no, or very few pre-manufactured parts, such as only the engine, transmission and tires.

Whether a motorcycle is custom, or manufactured by Harley-Davidson or another manufacturer, it generally includes a headlight and turn-signal lights, or turn indicators that warn other motorists of the motorcycle riders' intention to turn. The headlight, which may comprise a single light or two or more lights, may be mounted alone, or may be installed within a “fairing,” which is an enclosure on the front of the motorcycle that provides wind protection to the rider. Some fairings may have windshields, or windscreens while others may not include a windshield. Some fairings may be attached to the motorcycle frame, or other components, and thus not move relative to the frame, or the fairing may be attached to the forks and move as the handlebars are turned.

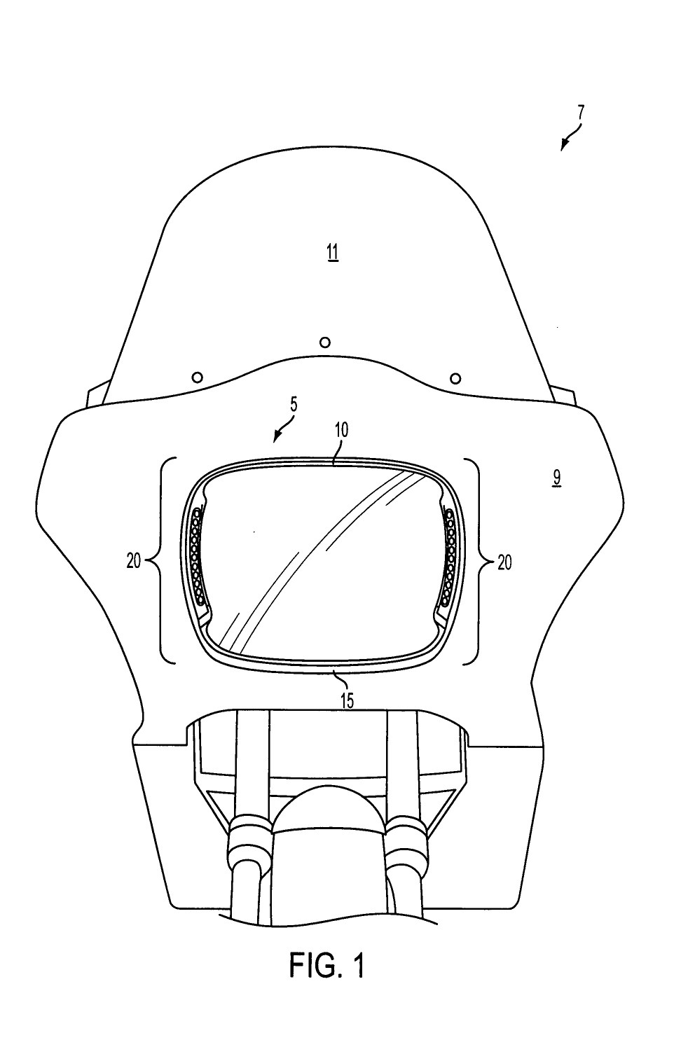

For example, as shown in FIG. 1, a motorcycle 7 includes a fairing 9 that has a windshield 11. The illustrated fairing 9 may be mounted to the frame (not shown) or other motorcycle components, and does generally not move relative to the motorcycle frame. It will be appreciated that the fairing 9 may have a shape that differs from what is illustrated, and may not include a windshield 11.

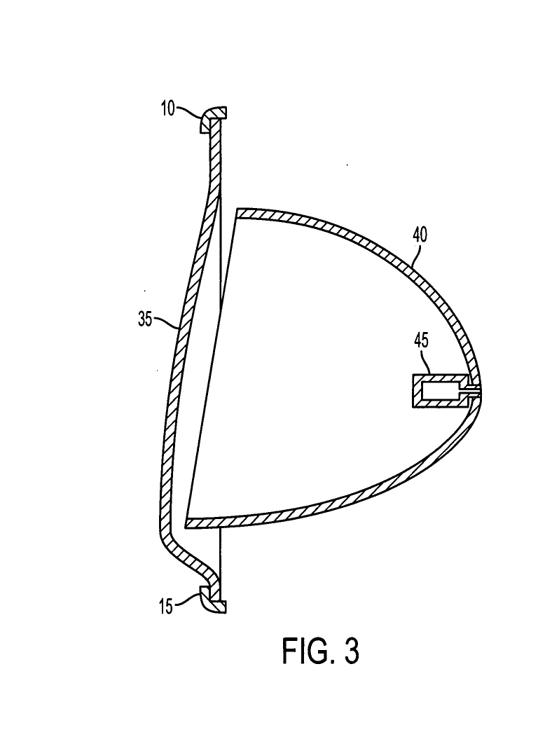

Referring now to FIGS. 1-3, the fairing 9 (shown in FIG. 1) includes an integrated light frame and turn signal assembly 5. The integrated light frame and turn signal assembly 5 is mounted in front of, or over the motorcycle headlight 40 (shown in FIG. 3). The integrated light frame and turn signal assembly 5 also comprises a top section 10, a bottom section 15 and two side sections 20 that combine to form a bezel or headlight frame that surrounds the headlight 40. The integrated light frame and turn signal assembly 5 also includes a lens 35 that may be clear (i.e., substantially transparent), or it may be opaque, tinted or “smoked” to partially obscure the headlight 40 from view. It will be appreciated by those skilled in the art that the tint may be virtually any color, such as gray, yellow, brown, blue or any other desired color. It will also be appreciated that the color or surface finish of the integrated light frame and turn signal assembly 5 may be as desired. For example, the integrated light frame and turn signal assembly 5 may be chrome, anodized in any color or finish, or painted a color to match the motorcycle, or painted any desired color.

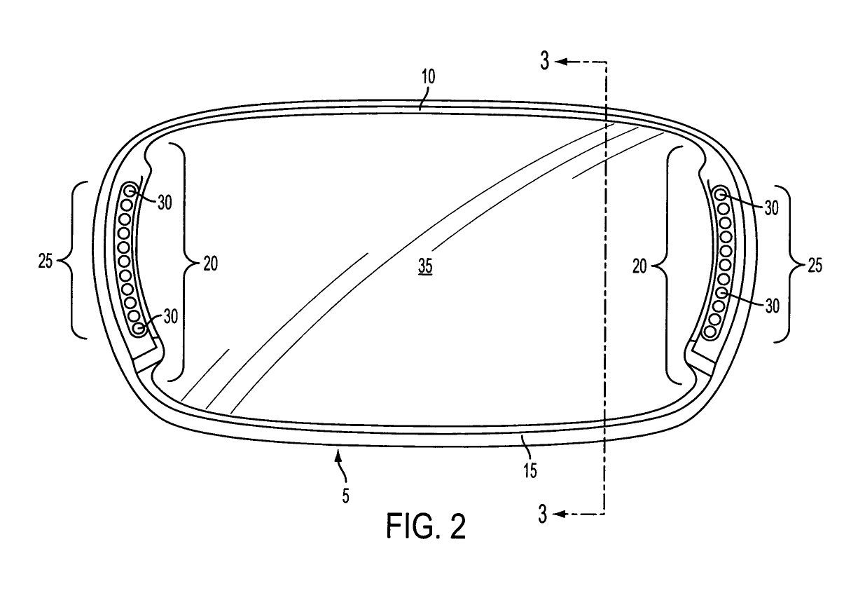

Referring now to FIG. 2, one feature of the integrated light frame and turn signal assembly 5 is that it includes two side sections 20 that have one or more lights 30 located in an illumination section 25. In one embodiment, each illumination section 25 comprises a plurality of light emitting diodes (LEDs) that may be any desired color, such as red, yellow, blue, green or any other desired color. Other embodiments of the illumination section 25 may comprise one or more incandescent lights, halogen lights, fluorescent lights, or any other type of device that emits electromagnetic radiation that is perceived by the human eye.

As shown in FIG. 2, the illumination sections 25 are positioned within the side sections 20 of the integrated light frame and turn signal assembly 5. One feature of the present invention is that the illumination sections 25 function as turn-signal indicators (i.e., turn lights). For example, a motorcycle rider, wishing to turn, activates a turn signal switch or other mechanism on the motorcycle 7. The turn signal switch activates the lights 30 located in the appropriate illumination section 25. With reference to FIG. 1, a rider wishing to turn left would activate the lights 30 in the illumination section 25 on the left side of the integrated light frame and turn signal assembly 5, and when wishing to turn right, the lights 30 in the illumination section 25 on the right side of the integrated light frame and turn signal assembly 5 would be activated. Activation of either illumination section 25 may illuminate the lights 30 in a flashing, strobe or other type of illumination pattern.

One advantage of the integrated light frame and turn signal assembly 5 is that both turn-signals are now integrated into the headlight 40 frame, or bezel thereby eliminating the turn signal lights that are usually mounted on stalks that extend from the fairing, or from other parts of the motorcycle. For motorcycle owners that wish to “customize” their motorcycles by “cleaning up” the motorcycle (i.e., eliminating components), the integrated light frame and turn signal assembly 5 eliminates the turn signals installed by the manufacturer.

Alternatively, for those motorcycle owners who wish to increase safety by increasing their “conspicuity” (i.e., their visibility), the additional lights provided by the integrated light frame and turn signal assembly 5 provide additional warning to on-coming motorists that the rider wishes to turn. In this case, the owner may wish to retain the original, manufacturer installed turn signals, and add the additional turn signals provided in the integrated light frame and turn signal assembly 5.

Referring now to FIG. 3, another embodiment of the present invention is illustrated. Some fairings 9 may be designed to closely fit around the headlight, or headlights 40 that each include a headlight bulb 45. This type of fairing 9, or other fairing designs, may be constructed to allow a portion of the headlight 40 to project out, or extend from the fairing 9. To accommodate this type of fairing 9, another embodiment integrated light frame and turn signal assembly 5 may include a lens 35 that is not substantially planar, but instead includes a bulge, or otherwise extends out from the top section 10, bottom section 15 and side sections 20 of the integrated light frame and turn signal assembly 5.

As shown in FIG. 3, a vertical plane 50 defined by the inner surface of the lens 35 where it mounts to the top section 10 and bottom section 15 is illustrated. A portion of the lens 35 extends outward from the vertical plane 50, and beyond the top section 10 and bottom section 15 of the integrated light frame and turn signal assembly 5. It will be appreciated that the size and shape of the outward-protruding section of the lens 35 may vary with different fairing 9 shapes. This protruding feature of the lens 35 allows the integrated light frame and turn signal assembly 5 to be fitted on fairings 9 that have headlights 40 that extend from the surface of the fairing 9.

In one embodiment the lens 35 may be manufactured from glass, but other embodiments may be manufactured of plastic or other suitable materials, such as, polymers, polyesters and other substantially transparent materials. Another embodiment of the integrated light frame and turn signal assembly 5 may include an “O-ring” or gasket (not shown) that may be positioned between the integrated light frame and turn signal assembly 5 and the fairing 9. The gasket may prevent moisture from entering the space between the headlight 40 and the lens 35.

The integrated light frame and turn signal assembly 5 may be fitted on two-wheel motorcycles (with or without a side-car), “trikes” (three-wheeled motorcycles), and micro-automobiles that have a single headlight, or a single headlight cluster.

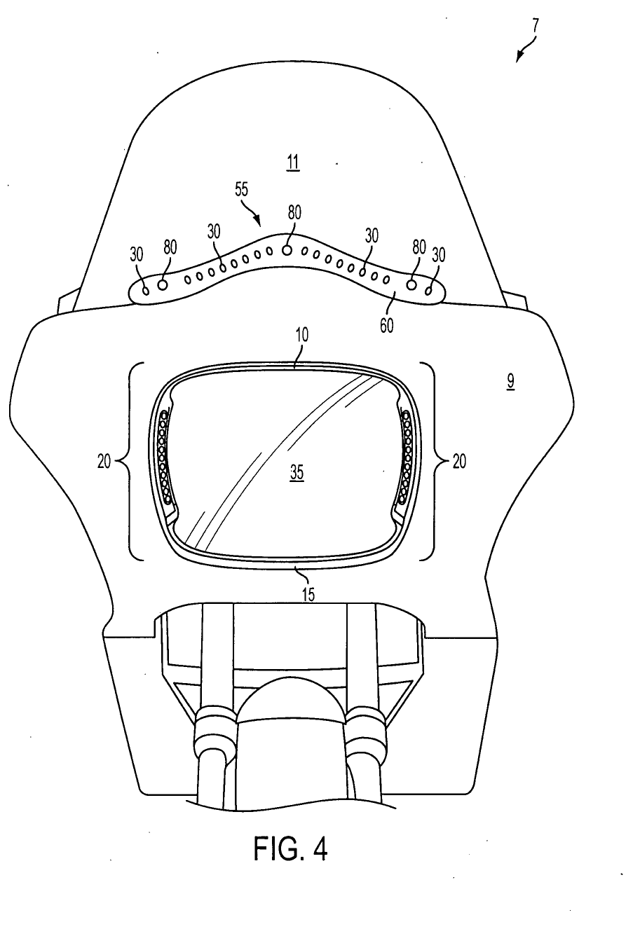

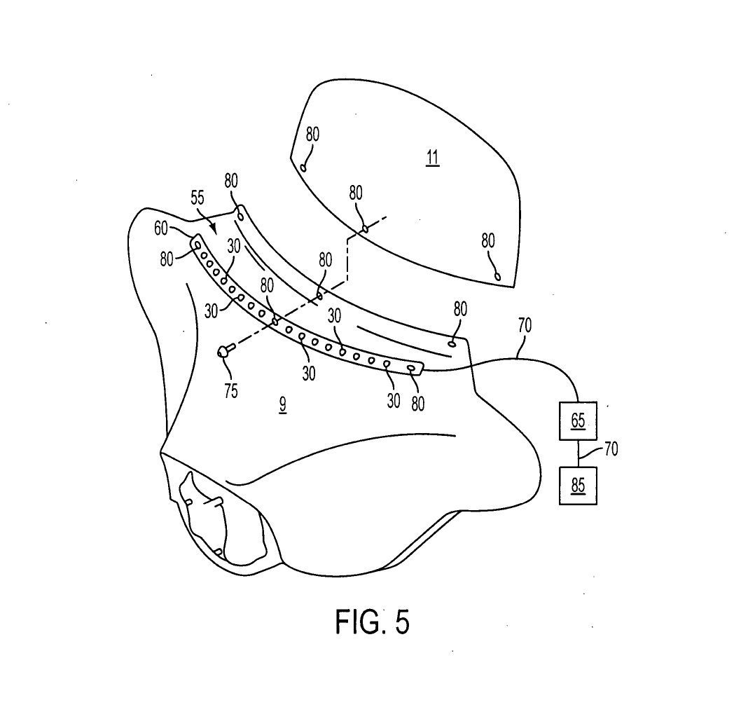

Referring now to FIGS. 4 and 5, an illuminated motorcycle fairing element 55 is illustrated. The illuminated motorcycle fairing element 55 provides several functions and features. One embodiment of the fairing element 55 secures the windshield 11 to the fairing 9, and also increases safety by increasing the “conspicuity” (i.e., the visibility) of the motorcycle 7 by including a plurality of lights 30. For example, as shown in FIG. 4, the illuminated motorcycle fairing element 55 includes multiple lights 30 along a majority of the fairing element 55 that provide additional warning and notice to on-coming motorists that a motorcycle is approaching.

The illuminated motorcycle fairing element 55 is generally installed on the fairing 9, described above, which is an enclosure on the front of the motorcycle 7 that provides wind protection to the rider. Some fairings 9 may have windshields, or windscreens 11 while others may not include a windshield. Some fairings 9 may be attached to the motorcycle frame, or other components, and thus not move relative to the frame, or the fairing 9 may be attached to the motorcycle forks and move as the handlebars are turned.

For example, as shown in FIGS. 4 and 5, a motorcycle 7 includes a fairing 9 that has a windshield 11. In this embodiment, the windshield 11 is fastened to the fairing 9 by fasteners 75 that extend through the trim, or strip 60, the fairing 9 and the windshield 11, as shown in FIG. 5, so that the strip 60 is positioned outermost, with the fairing 9, or the windshield 11 adjacent to the strip 60. The trim, or strip 60 includes fastener apertures 80, as does the fairing 9 and the windshield 11, that receive the fasteners 75. It will be appreciated that virtually any type of fastener 75 may be employed, such as threaded bolts and nuts, pins, rivets, and other types of fasteners.

It will also be appreciated that the three elements: the fairing 9; the windshield 1; and the strip 60 are positioned so that they contact at least one of each other, or are adjacent to each other, and each may have a shape that differs from what is illustrated in FIGS. 4 and 5. For example, FIG. 4 illustrates a fairing 9 that includes a “peak” or “bump” at the interface between the fairing 9 and the windshield 11. To fit this bump, or peak, the strip 60 may be shaped accordingly, so as to cover a portion of the interface area (as shown). In contrast, FIG. 5 illustrates a strip 60 that has a continuous curvature, with no additional bumps, peaks, or secondary curvatures. This is because the fairing 9 and windshield 11 do not include the bump or peak shown in FIG. 4. The illuminated motorcycle fairing element 55 may be shaped to fit any fairing 9, regardless of shape or size.

Additionally, the illuminated motorcycle fairing element 55 may be installed on a fairing 9 that does not include a windshield 11. For example, the illuminated motorcycle fairing element 55 may be installed on a smaller, abbreviated fairing 9 that does not include a windshield 11. However, the illuminated motorcycle fairing element 55 would still be desirable to provide additional visibility of the motorcycle 7 to other motorists. That is, the illuminated motorcycle fairing element 55 may also provide an ornamental, or cosmetic improvement to a motorcycle 7, regardless of whether its fairing 9 included a windshield.

The strip 60 may be in the shape of a slender band, or narrow piece of material, such as metal, plastic, or an alloy, such as aluminum. For example, the strip 60 may be a metal that is chrome plated, or the strip 60 may comprise an anodized aluminum in any color or finish, or the strip 60 may be plastic, metal or aluminum that is painted any desired color. One embodiment of the strip 60 may range in length from about 10 inches to over 24 inches, and a width of the strip 60 may range from about one-half of an inch to over three inches. It will be appreciated that the dimensions of the strip 60 may vary to accommodate different fairings and windshield, and may be shorter or longer, and narrower or wider than herein described.

In addition to one or more fastener apertures 80, the strip 60 includes a plurality of apertures that contain lights 30. The number of lights 30 may vary (for example, from 2 to 20, or more) depending upon the size of the strip 60. In one embodiment, the lights 30 may be a plurality of light emitting diodes (LEDs) that may be any desired color, such as red, yellow, blue, green or any other desired color. Alternatively, the lights 30 may comprise one or more incandescent lights, halogen lights, fluorescent lights, or any other type of device that emits electromagnetic radiation that is perceived by the human eye. In an alternative embodiment, the lights 30 in the strip 60 may be covered by a substantially continuous piece of substantially transparent material, either as an elongated single strip of “lens”-like material, or two pieces of elongated lens-like material, one on each side of the strip 60 (not shown). Similar to the lens 35 described above, the lens-like material may be substantially transparent, or it may be opaque, tinted or “smoked” to partially obscure the lights 30 from view. It will be appreciated by those skilled in the art that the tint may be virtually any color, such as gray, yellow, brown, blue or any other desired color.

In one embodiment, the illuminated motorcycle fairing element 55 comprises a strip or band 60 of material, with a plurality of lights 30 affixed thereto, with related wiring 70 and at least one connector 65 that is coupled to the motorcycle wiring harness 85 that provides electricity to the lights 30.

For example, the lights 30 may be coupled to the turn signal switch that activates the turn indicator lights (not shown) on the motorcycle 7. In one embodiment of the illuminated motorcycle fairing element 55, four electrical connectors 65 (two adjacent to each end of the strip 60) are employed. Each electrical connector 65 is a commonly available three (3) or six (6), or other, pin connector that is well known to those skilled in the art. During installation, the connector on the motorcycle wiring harness 85 for each turn signal indicator is un-plugged, and the respective connector 65 is plugged into the wiring harness 85. The turn signal indicator is then plugged into the second respective connector 65, thereby connecting the turn signal indicator in series with the illuminated motorcycle fairing element 55.

It will be appreciated that other arrangements for electrically powering the illuminated motorcycle fairing element 55 may be employed. For example, the lights 30 may be turned on when the motorcycle headlight 40 is turned on, or the lights 30 may be activated by a separate switch mounted on the motorcycle 7 that enables illumination of the lights 30 at any time, as desired by the motorcycle operator.

In the first embodiment described above, the lights 30 contained in the illuminated motorcycle fairing element 55 function as either primary, or secondary turn-signal indicators (i.e., turn lights). That is, the motorcycle 7 may not have any dedicated turn signal lights, and the lights 30 contained in the illuminated motorcycle fairing element 55 function as the only, or primary turn signal indicators.

Alternatively, the lights 30 contained in the illuminated motorcycle fairing element 55 may function as secondary turn-signal indicators. For example, a motorcycle rider, wishing to turn, activates a turn signal switch or other mechanism on the motorcycle 7. The turn signal switch activates the factory-installed (i.e., original motorcycle manufacturer) turn signal indicators on the motorcycle 7, which also activates the lights 30 in the illuminated motorcycle fairing element 55 located in the appropriate side of the motorcycle 7.

In another embodiment, with reference to FIGS. 1 and 4-5, a rider wishing to turn left would activate the left turn signal switch (not shown), that would activate the lights 30 on the illuminated motorcycle fairing element 55 that are on the same side of the fairing 9 as the illumination section 25 on the left side of the integrated light frame and turn signal assembly 5. Similarly, when wishing to turn right, the right turn signal switch (not shown) is activated, and the lights 30 in the illuminated motorcycle fairing element 55 that are on the same side of the fairing 9 as the illumination section 25 on the right side of the integrated light frame and turn signal assembly 5 would be activated. The “sides” of the motorcycle are defined by a vertical plane that bisects the center of the motorcycle, from the front to the rear of the motorcycle 7.

The lights 30 on the illuminated motorcycle fairing element 55 may be illuminated in a flashing, strobe, consecutive, sequential, or other type of illumination pattern. For example, when functioning as primary, or secondary turn signal indicators, the light 30 that is closest to the centerline of the motorcycle 7 illuminates first, then the light adjacent to that one illuminates, and so on, until the light at the tip of the strip 60 is finally illuminated. That is, one-half of the lights 30 are illuminated in a sequential, or consecutive fashion when employed as turn-signal indicators.

One advantage of the illuminated motorcycle fairing element 55 is that it may supplement the integrated light frame and turn signal assembly 5, in that both devices (5 and 55) function as turn-signal indicators, thereby eliminating the turn signal lights that are usually mounted on stalks that extend from the fairing, or from other parts of the motorcycle. For motorcycle owners that wish to “customize” their motorcycles by “cleaning up” the motorcycle (i.e., eliminating components), the illuminated motorcycle fairing element 55 and the integrated light frame and turn signal assembly 5 eliminates the turn signals installed by the manufacturer.

Alternatively, for those motorcycle owners who wish to increase safety by increasing their “conspicuity” (i.e., their visibility), the additional lights 30 provided by the illuminated motorcycle fairing element 55 provide additional notice to on-coming motorists, enabling the motorist to see the motorcycle 7 earlier than a motorcycle without the illuminated motorcycle fairing element 55 installed. In this case, the motorcycle owner may wish to retain the original, manufacturer installed turn signals, and add the illuminated motorcycle fairing element 55.

It will be appreciated that the illuminated motorcycle fairing element 55 may be installed on any existing type or model of motorcycle having a fairing, or on other models with fairings yet to be manufactured. In addition, the illuminated motorcycle fairing element 55 may be installed on a “custom” motorcycle, which is a motorcycle that differs from a manufacturer-produced model. For example, a custom motorcycle may be a Harley-Davidson FXST Softail Standard that has had specific parts either added, removed or modified. Or, a custom motorcycle may be built from scratch, using no, or very few pre-manufactured parts, such as only the engine, transmission and tires. In addition, the illuminated motorcycle fairing element 55 may be fitted on two-wheel motorcycles (with or without a side-car), and “trikes” (three-wheeled motorcycles).

Thus, it is seen illuminated motorcycle fairing element is provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

What is claimed is:

1. A motorcycle apparatus, comprising:
a trim element comprising an elongated member, the trim element sized to fit adjacent to a motorcycle fairing and a motorcycle windshield;
a plurality of light elements coupled to the trim element; and
at least one electrical connector communicating with at least one of the plurality of light elements, the electrical connector structured to couple to a motorcycle wiring harness.

2. The motorcycle apparatus of claim 1, where the trim element is positioned adjacent to an interface between the motorcycle fairing and the motorcycle windshield.

3. The motorcycle apparatus of claim 1, where the elongated member comprises a length sufficient to span at least half of a width of the motorcycle windshield, with the motorcycle windshield width measured at an interface between the motorcycle fairing and the motorcycle windshield.

4. The motorcycle apparatus of claim 1, where the plurality of light elements comprises a range of light elements between two and twenty light elements.

5. The motorcycle apparatus of claim 1, where the motorcycle wiring harness includes at least two turn signal connectors for at least two turn signal indicators, and the at least one electrical connector comprises at least two electrical connectors structured to couple to each of the two turn signal connectors.

6. The motorcycle apparatus of claim 1, where the plurality of light elements are structured to provide a turn signal indication.

7. The motorcycle apparatus of claim 1, where each of the plurality of light elements comprises at least one light emitter selected from a group consisting of: an incandescent light, a light-emitting diode (LED), a fluorescent light, and a halogen light.

8. A motorcycle apparatus of claim 1, where the plurality of light elements comprise two groups of lights, and each group of lights illuminates sequentially.

9. A motorcycle apparatus, comprising:
a trim element comprising an elongated member, the trim element sized to fit adjacent to a motorcycle fairing and a motorcycle windshield;
a plurality of light elements coupled to the trim element, the plurality of light elements providing a turn signal indication;
at least two electrical connectors communicating with the plurality of light elements, the electrical connectors structured to couple to a motorcycle wiring harness that includes at least two turn signal connectors for at least two turn signal indicators.

10. A motorcycle apparatus of claim 9, where the trim element comprises at least four electrical connectors communicating with the plurality of light elements, the electrical connectors structured to couple to a motorcycle wiring harness that includes at least two turn signal connectors for at least two turn signal indicators, the coupling occurring in series so that when at least one of the turn signal indicators is activated, a respective group of the plurality of light elements is also activated.

11. The motorcycle apparatus of claim 10, where the respective group of the plurality of light elements comprises approximately one-half of the plurality of light elements.

12. A motorcycle apparatus of claim 9, where the plurality of light elements comprise two groups of lights, and each group of lights illuminates sequentially.

13. The motorcycle apparatus of claim 9, where each of the plurality of light elements comprises at least one light emitter selected from a group consisting of: an incandescent light, a light-emitting diode (LED), a fluorescent light, and a halogen light.

14. The motorcycle apparatus of claim 9, where the turn signal indication comprises either a left-turn indication or a right-turn indication.
